(19) United States
(12) Patent Application Publication
(10) Pub. No.: US 2025/0198970 A1
(43) Pub. Date: Jun. 19, 2025

(54) METHOD AND SYSTEM FOR ENHANCING ULTRASONIC GUIDED WAVE SIGNAL BASED ON MULTI-MODAL RECOGNITION AND FUSION

(71) Applicant: SOUTH CHINA UNIVERSITY OF TECHNOLOGY, Guangzhou (CN)

(72) Inventors: Xiaobin HONG, Guangzhou (CN); Jinfan LIN, Guangzhou (CN)

(73) Assignee: SOUTH CHINA UNIVERSITY OF TECHNOLOGY, Guangzhou (CN)

(21) Appl. No.: 18/842,803

(22) PCT Filed: Oct. 31, 2023
(86) PCT No.: PCT/CN2023/128619

§ 371 Date: Aug. 30, 2024

(30) Foreign Application Priority Data
Feb. 22, 2023 (CN) 202310150714.X

(51) Int. Cl. G01N 29/46; G01N 29/12; G01N 29/22

(52) U.S. Cl. CPC G01N 29/46; G01N 29/12; G01N 29/221

(57) ABSTRACT

The present invention discloses a method and a system for enhancing an ultrasonic guided wave signal based on multi-modal recognition and fusion. The method includes: solving an ultrasonic guided wave frequency dispersion curve of a detected structure, selecting target detection modes, and setting the strongest energy mode as the main mode; forming a frequency dispersion dictionary and obtaining sub-signals, then converting their abscissa axes from time to signal source distances; grouping sub-signals with similar source distances, classifying them as single modal or main mode conversion sub-signals, and removing interference signals; and resampling the classified sub-signals at a uniform frequency, extracting half-wave envelope signals, and superposing them within each source group to obtain an enhanced target signal

### TECHNICAL FIELD

The present invention relates to the technical field of non-destructive testing, and in particular to a method and a system for enhancing an ultrasonic guided wave signal based on multi-modal recognition and fusion.

### BACKGROUND

An ultrasonic guided wave has advantages of low attenuation, a long propagation distance, high detection time efficiency, and the like, and is widely used in rapid non-destructive testing of structures such as a pipe and plate. As requirements for damage detection are increasingly higher. multi-modal fusion and enhancement of the ultrasonic guided wave is of great significance to improve key detection performance such as damage detection positioning accuracy and a detection resolving capability.

Due to multi-mode and dispersion characteristics of the ultrasonic guided wave, phase velocities and group velocities of different modes in ultrasonic guided wave collected signals are different. An excitation manner that can generate a few-modal or even single modal low-frequency ultrasound signal is usually used for detection, helping to reduce the number of ultrasonic guided wave modes and an information analysis difficulty. thereby implementing spatio-temporal focusing of a single modal envelope signal of a separated array ultrasonic guided wave. Multi-mode of the ultrasonic guided wave will increase a difficulty in ultrasonic guided wave signal processing, causing a lot of imaging artifacts, and increasing a possibility of damage misjudgment. However, the multi-mode contained in a detection signal also carries more damage information. Therefore, the multi-mode characteristic of the ultrasonic guided wave is fully used to implement multi-modal fusion and enhancement, helping to improving sensitivity and positioning accuracy of an array ultrasonic guided wave signals.

### SUMMARY

To solve the above technical problem, the present invention is intended to provide a method and a system for enhancing an ultrasonic guided wave signal based on multi-modal recognition and fusion, to implement separation and recognition of an ultrasonic guided wave multi-modal signal and a conversion mode signal, and further implement signal enhancement based on multi-modal fusion.

The purpose of the present invention is achieved using the following technical solutions:
a method for enhancing an ultrasonic guided wave signal based on multi-modal recognition and fusion, including:
A: solving an ultrasonic guided wave frequency dispersion curve of a detected structure. selecting n modes as target detection modes, and setting a mode with a strongest signal energy as a main mode;
B: solving, as atomic signals, a series of signals of an ultrasonic guided wave excitation signal that propagates within a detected object through the target detection mode, to form an ultrasonic guided wave frequency dispersion dictionary;
C: performing modal signal separation and recognition on the ultrasonic guided wave signal by using the ultrasonic guided wave frequency dispersion dictionary, to obtain a series of sub-signals:
D: converting abscissa axes of sub-signals from time to signal source distances based on a modal recognition result and modal group velocity of the sub-signals;
E: determining different modal sub-signals with a same or similar signal source distance as single modal sub-signals and dividing the different modal sub-signals into a same signal source target group, and determining other sub-signals as potential mode conversion sub-signals:
F: based on the signal source distance and modal group velocity of the signal source target group. assuming that the potential mode conversion sub-signal as a modal conversion signal of a main modal signal at a signal source, and converting an abscissa axis of the potential mode conversion sub-signal from time to a signal source distance;
G: if the signal source distance of the potential mode conversion sub-signal is the same as or similar to a signal source distance of the signal source target group, determining the potential mode conversion sub-signal as a main mode conversion sub-signal and classifying the potential mode conversion sub-signal into the signal source target group, and determining other sub-signals as interference signals. and removing other sub-signals;
H: resampling the single modal sub-signals and the main mode conversion sub-signals at a same sampling frequency and extracting half-wave envelope signals; and
I: superposing half-wave envelope signals of resampled sub-signals of the same signal source target group, to obtain an enhanced signal of a target signal source.

A system for enhancing an ultrasonic guided wave signal based on multi-modal recognition and fusion, including:
an ultrasonic guided wave excitation probe and an ultrasonic guided wave receiving probe, configured to excite and receive an ultrasonic guided wave signal respectively;
an excitation module, generating and amplifying an excitation signal and generating an ultrasonic guided wave propagation signal within a detected structure through the ultrasonic guided wave excitation probe;
a collection-synchronous transmission module, collecting a detection signal through the ultrasonic guided wave receiving probe and synchronously transmitting the detection signal to a data processing platform;
a detection control module. configured to control the excitation mode and the collection-synchronous transmission module; and
the data processing platform, including a frequency dispersion dictionary database generation module and a fusion and enhancement processing module of a multi-modal ultrasonic guided wave signal.

Compared with the conventional technologies, one or more embodiments of the present invention have the following beneficial effects.
1. According to the present invention, the multi-modal characteristic of the ultrasonic guided wave is fully used. damage information carried by different modes is separated and fully used, recognition and fusion enhancement of the multi-modal ultrasonic guided wave is implemented based on rich multi-modal information, a damage signal amplitude is greatly improved, and a signal-to-noise ratio of a damage signal and damage detection resolving capability are increased.
2. When a final enhanced signal is used for further imaging, no artifact is generated, false detection is less likely to occur, and a damage detection resolving capability and a precise positioning capability are improved.
3. Separation and recognition of the ultrasonic guided wave multi-modal signal and conversion modal signal are implemented, signal enhancement based on multi-modal fusion is further implemented, a capability for processing a multi-damage complex signal is improved, and advantages are provided for reducing artifacts, recognizing a multi-damage target. and the like.

### BRIEF DESCRIPTION OF DRAWINGS

FIG. 1 is a flow chart of a method for enhancing an ultrasonic guided wave signal based on multi-modal recognition and fusion;

FIG. 2A is an example diagram of a frequency dispersion curve and wave number of an aluminum plate with a thickness of 5 mm;

FIG. 2B is an example diagram of a frequency dispersion curve and group velocity of an aluminum plate with a thickness of 5 mm;

FIG. 3 is a schematic example diagram of a simulation model of an aluminum plate multi-damage test block with a thickness of 5 mm;

FIG. 4 is a schematic example diagram of a time domain waveform of a collected ultrasonic guided wave;

FIG. 5 is a schematic example diagram of a collected ultrasonic guided wave after modal signal separation and recognition;

FIG. 6 is a schematic example diagram of sub-signals after first signal source distance conversion;

FIG. 7 is a schematic example diagram of sub-signals after second signal source distance conversion;

FIG. 8 is a schematic example diagram of a resampled signal and a half-wave envelope signal of a single modal sub-signal and a main mode conversion sub-signal;

FIG. 9 is a schematic example diagram of enhanced signals of two target signal sources;

FIG. 10 is a schematic example diagram of a half-wave envelope signal of an originally collected signal;

FIG. 11 is a block diagram of a system for enhancing an ultrasonic guided wave signal based on multi-modal recognition and fusion;

FIG. 12 is a block diagram of a data processing platform;

FIG. 13 is a block diagram of a frequency dispersion dictionary database generation module; and

FIG. 14 is a block diagram of a fusion and enhancement processing module of a multi-modal ultrasonic guided wave signal.

### DESCRIPTION OF EMBODIMENTS

To make objectives, technical solutions, and advantages of the present invention clearer, the present invention will be further described in detail with reference to embodiments and accompanying drawings.

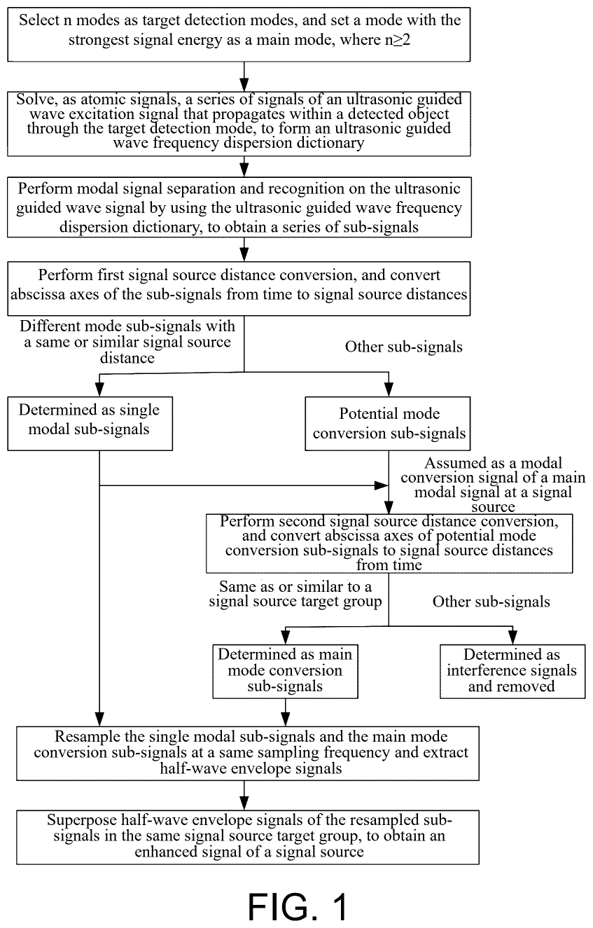

FIG. 1 is a process of a method for enhancing an ultrasonic guided wave signal based on multi-modal recognition and fusion, including the following steps.

Step 1: Solve an ultrasonic guided wave frequency dispersion curve of a detected structure, and obtain a wave number diagram and a group velocity diagram of the ultrasonic guided wave that propagates in the detected structure; and based on common damage types of the detected structure, a frequency ƒ at which the ultrasonic signal is excited, an energy ratio of each mode, and sensitivity to a target damage type, select n modes as target detection modes from the group velocity diagram, where n≥2, and set a mode with the strongest signal energy as a main mode.

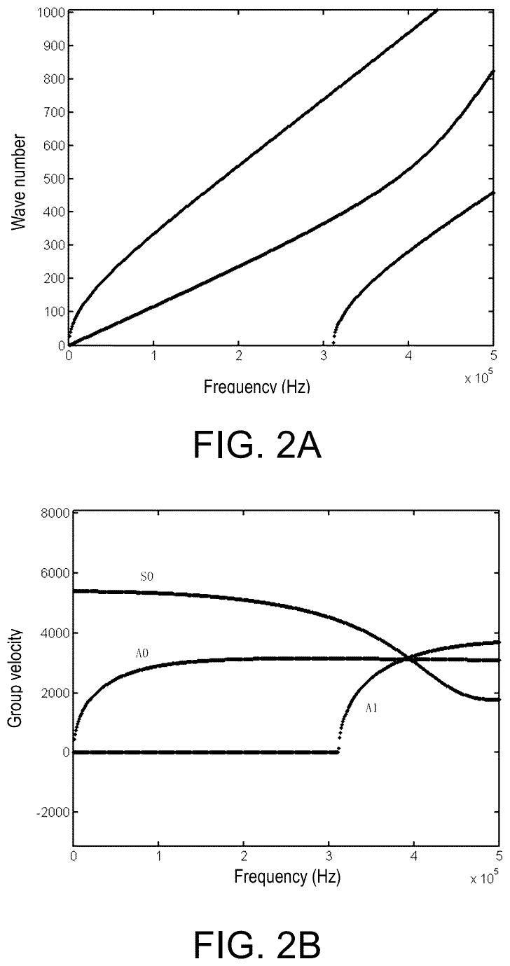

Taking an aluminum plate with a thickness of 5 mm as an example, the wave number diagram and group velocity diagram of the ultrasonic guided wave that propagates in the aluminum plate are shown in FIG. 2A and FIG. 2B. If a 150 kHz Hanning window is used to modulate a five-peak sinusoidal signal pulse string as an excitation signal, when a 45° inclination angle is used for excitation, an A0 mode and an S0 mode may be selected as target detection modes, and the A0 mode with the strongest signal energy is set as the main mode.

Step 2: Solve, as atomic signals, a series of signals of an ultrasonic guided wave excitation signal that propagates for a distance set within a detected object through a target detection mode, to form an ultrasonic guided wave frequency dispersion dictionary, which specifically includes:

Based on an ultrasonic guided wave frequency dispersion curve and a detection range of the detected structure, assuming the propagation distance set l={lₙ|lₙ=l₀+nΔl} with an equal spacing of Δl between elements;
assuming that a signal of the excited ultrasonic signal e(t) that propagates for a propagation distance l in the tested structure is s(l, t)=Σₘ₌₁^{M}e(t)*p(l, ƒ, m), where M is the number of guided wave modes, * is convolution, and p(l, ƒ, m) is a dispersion function; solving an atomic signal s(l, t, m) with a mode of m by using an inverse Fourier transform of a Fourier transform S(l, w), which is expressed as s(l, t, m)=(∫_{-∞}^{+∞}S(0, w)e^{-i(wt-k(w)l)}dw)*p(l, ƒ, m), where k(w) is a wave number function of a frequency w; and solving, through a given target detection mode. the series of signals of the excitation signal that propagates for the propagation distance set l within the detected through n target detection modes. to form the ultrasonic guided wave frequency dispersion dictionary.

Step 3: Perform modal signal separation and recognition on the ultrasonic guided wave signal s(i, j) by using the ultrasonic guided wave frequency dispersion dictionary. to obtain a series of sub-signals.

Further optimizably, signal sparse decomposition is performed on the collected ultrasonic guided wave signal based on a matching pursuit algorithm by using the modal signal separation and recognition. A sub-signal is separated from a collected signal s(i,j), an atomic signal matching the sub-signal is set as s′ₙ(l′, t, m′), and a mode m′ and a propagation distance l′ that matches the atomic signal in the ultrasonic guided wave frequency dispersion dictionary is recorded.

Further optimizably, final residual signal energy obtained by using the modal signal separation is not greater than 20% of original signal energy.

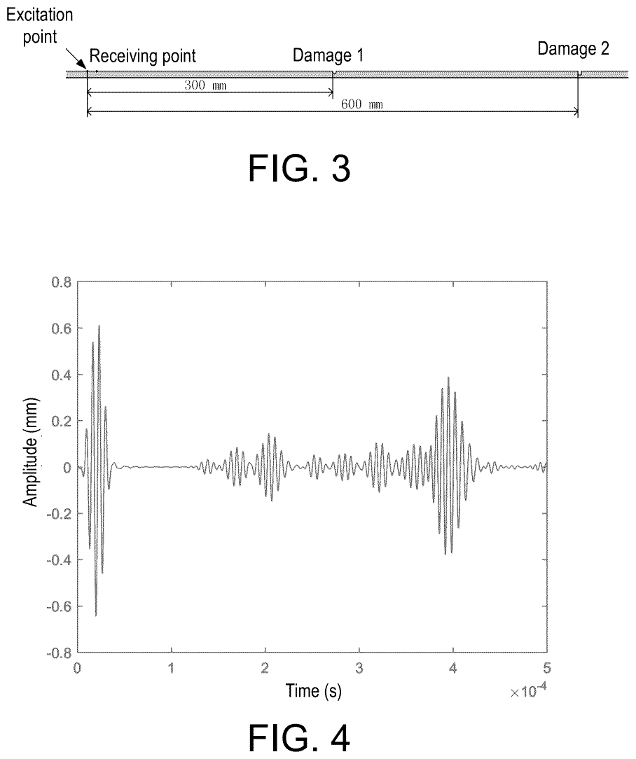

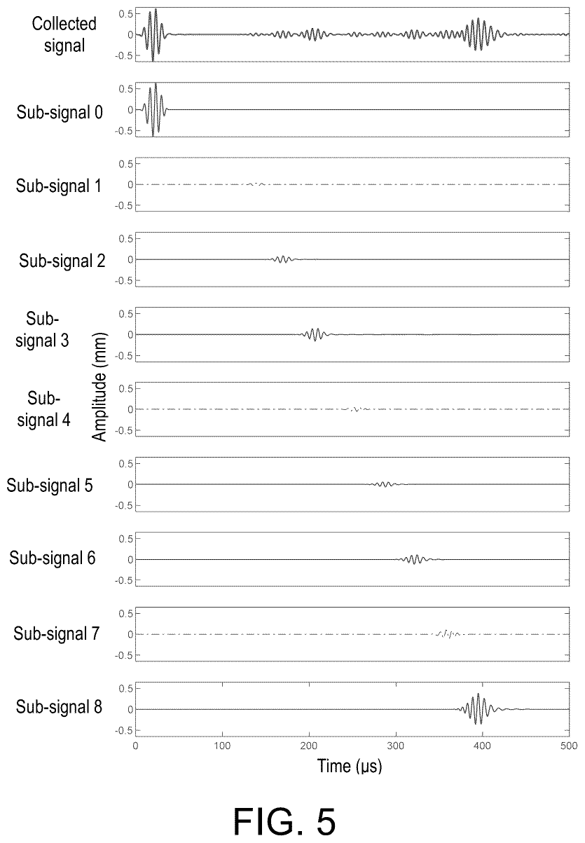

For example, refer to FIG. 3. There are two damages at distances of 300 mm and 600 mm from a test block to signal excitation points, respectively. A five-peak sinusoidal signal pulse string modulated by 150 kHz Hanning window is used as the excitation signal and excited at a 45° inclination angle. FIG. 4 is a vibration simulation signal collected at a signal collection point that is at a distance of 10 mm away from the excitation point. FIG. 5 is a series of sub-signals obtained by matching and separating the collected ultrasonic guided wave signal with the atomic signal of the ultrasonic guided wave frequency dispersion dictionary through the matching pursuit algorithm. The used ultrasonic guided wave frequency dispersion dictionary is an ultrasonic guided wave frequency dispersion dictionary for an aluminum plate with a thickness of 5 mm, which is formed by a series of atomic signals in an A0 mode and a series of atomic signals in an S0 mode. For obvious distinction, in a sub-signal modal recognition result shown in FIG. 5. the A0 mode is represented by solid lines, the S0 mode is represented by dot-dash lines, and a direct wave signal is set as a sub-signal 0 and is removed.

Step 4: Based on a modal recognition result and modal group velocity of the sub-signals, perform first signal source distance conversion, and convert abscissa axes of the sub-signals from time to signal source distances.

The signal source distance is a distance between a damage, a structural boundary, or an interface and an excitation point, and can be solved based on a group velocity of a recognition mode of the sub-signal at an excitation frequency. The group velocity is obtained from a frequency dispersion curve. When the propagation distance l′ is much greater than a distance between the excitation point and a signal receiving point, the signal source distance is approximately equal to l′/2.

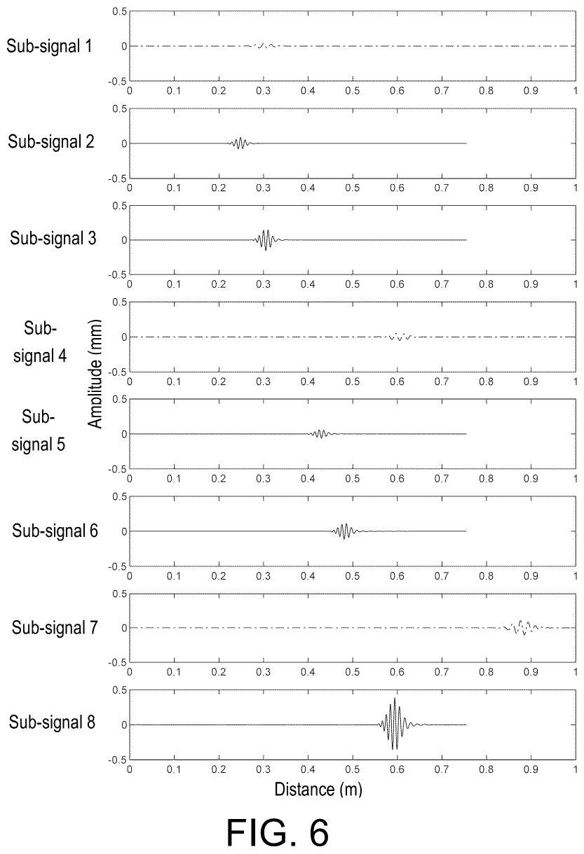

For example, among the sub-signals shown in FIG. 5. a sub-signal recognized as the A0 mode is solved based on a group velocity of the A0 mode in the frequency dispersion curve at an excitation frequency of 150 k and based on distance relationships between the signal source and the excitation point. and between the signal source and the receiving point. Similarly, a sub-signal recognized as the S0 mode is solved based on a group velocity of the S0 mode in the frequency dispersion curve at the excitation frequency of 150 k. Refer to FIG. 6. First signal source distance conversion is performed on sub-signals in FIG. 5 based on the modal recognition result and the modal group velocity, and the abscissa axes are converted from time to the signal source distances.

Step 5: Determine different modal sub-signals with a same or similar signal source distance as single modal sub-signals and divide the different modal sub-signals into a same signal source target group, and determine other sub-signals as potential mode conversion sub-signals.

For example, refer to FIG. 6. After first signal source distance conversion, distances between wave packets of a sub-signal 1 and a sub-signal 3. and between wave packets of a sub-signal 4 and a sub-signal 6 are the same or similar, and the sub-signal 1 and sub-signal 3, and the sub-signal 4 and sub-signal 8 are determined as single modal sub-signals and are divided into the following two signal source target groups. A signal source distance of a signal source target group 1 is 300 mm. and a signal source distance of a signal source target group 2 is 600 mm. A sub-signal 2, a sub-signal 5, a sub-signal 6, and a sub-signal 7 are potential mode conversion signals.

Step 6: Based on the signal source distance and modal group velocity of the signal source target group, assume the potential mode conversion sub-signal as a modal conversion signal of a main modal signal at a signal source. perform second signal source distance conversion, and convert an abscissa axis of the potential mode conversion sub-signal from time to the signal source distance.

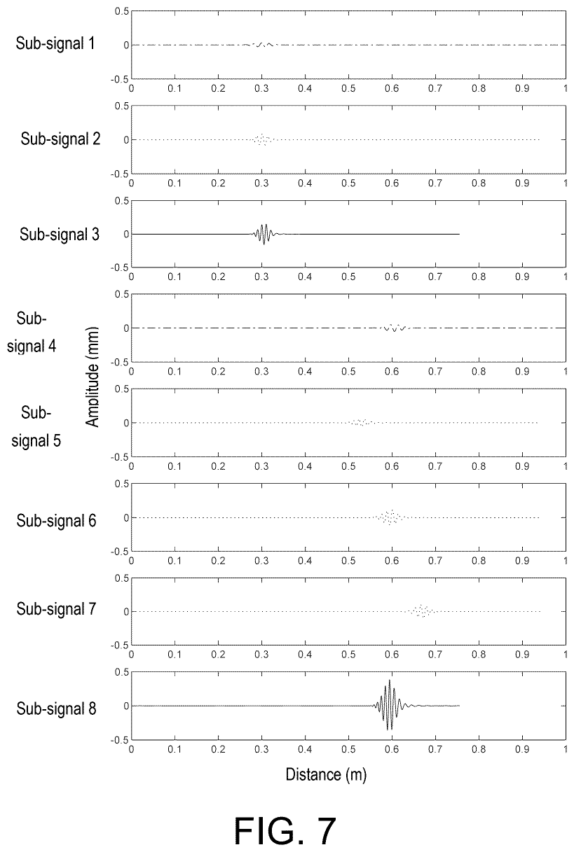

For example, the modal conversion signal in FIG. 6 is assumed as a modal conversion signal in an S0 mode converted from an A0 main mode signal at the signal source. and solving is performed based on distance relationships between group velocities, signal sources, excitation points, and receiving points in the S0 mode and the A0 mode at 150 KHz. FIG. 7 is conversion of the abscissa axis of the potential mode conversion sub-signal from time to the signal source distance.

Step 7: If the signal source distance of the potential mode conversion sub-signal is the same as or similar to a signal source distance of the signal source target group, the potential mode conversion sub-signal is determined as a main mode conversion sub-signal and classified into the signal source target group. Other sub-signals are determined as interference signals and removed.

The main mode conversion sub-signal is a signal in case of a damage to a main mode or mode conversion occurring on a structural boundary or an interface.

For example, refer to FIG. 7. A signal source distance of a sub-signal 2 is the same as or similar to a signal source distance of a signal source target group 1. The sub-signal 2 is determined as the main mode conversion sub-signal and classified into the signal source target group 1. Similarly, a sub-signal 6 is classified into a signal source target group 2. A sub-signal 5 and a sub-signal 7 are determined as interference signals and removed. For obvious distinction. in a sub-signal modal recognition result shown in FIG. 7, the A0 mode is represented by solid lines, the S0 mode is represented by dot-dash lines, and the potential mode conversion sub-signals are represented by dashed lines.

Step 8: Resample the single modal sub-signal and the main mode conversion sub-signal at a same sampling frequency and extract half-wave envelope signals.

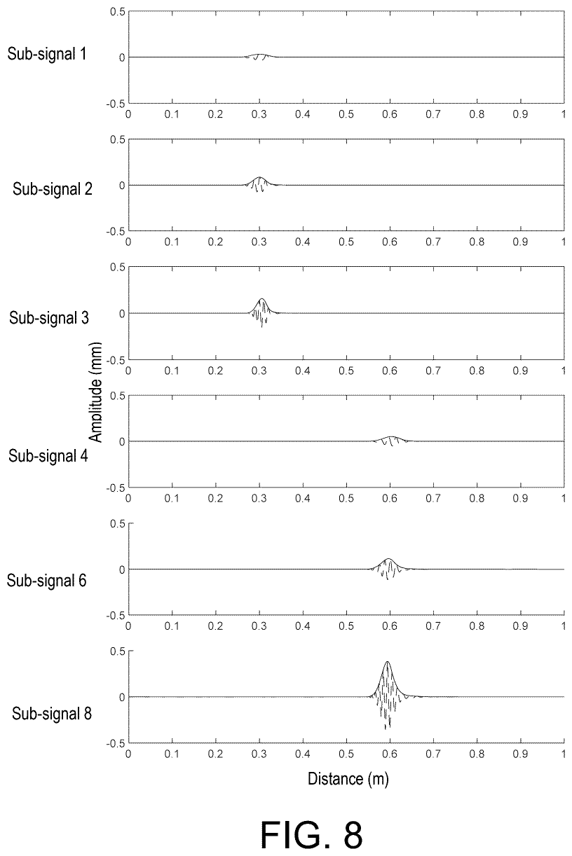

For example, refer to FIG. 8. Dotted lines are resampled signals of the single modal sub-signal and the main mode conversion sub-signal, and solid lines are the half-wave envelope signals.

Step 9: Superpose half-wave envelope signals of the resampled sub-signals of the same signal source target group, to obtain an enhanced signal of a target signal source.

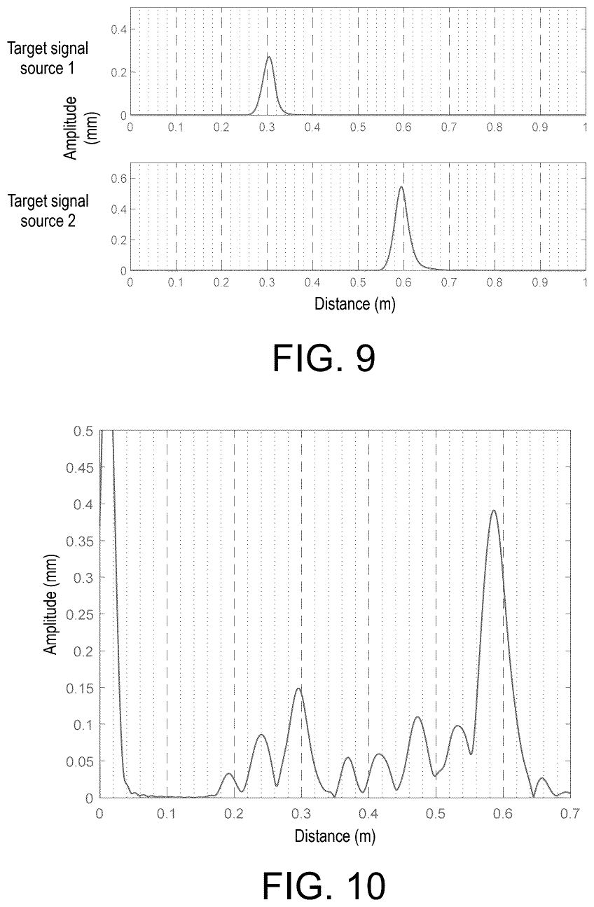

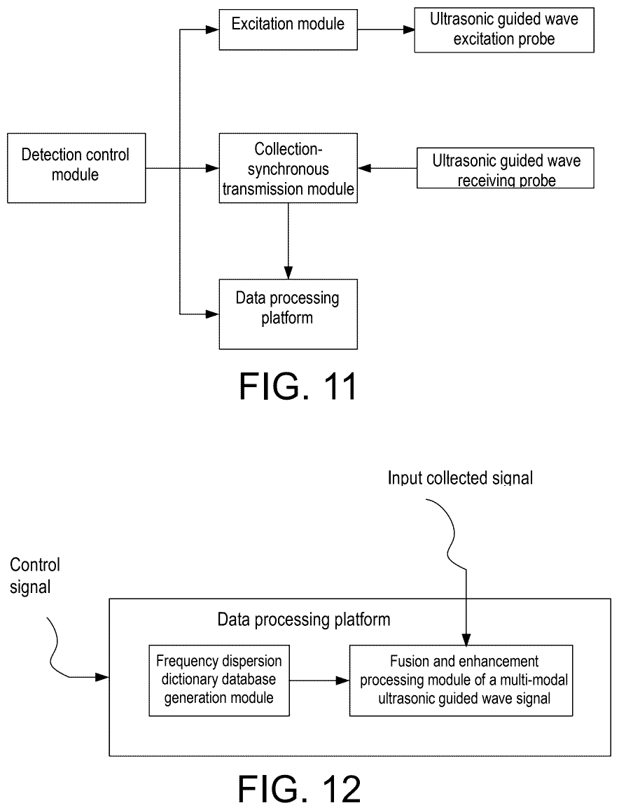

For example, refer to FIG. 9. Sub-signals in the signal source target group 1 and the signal source target group 2 are respectively superimposed to obtain enhanced signals of a target signal source 1 and a target signal source 2.

To better describe the technical effect of the present invention, examples are provided below with reference to FIG. 8. FIG. 9, and FIG. 10. Refer to FIG. 10. To perform damage analysis in consideration of only the main mode (A0 mode) of the ultrasonic guided wave, a propagation distance is calculated using the group velocity of the excitation signal in the A0 mode at a 150 kHz, and the signal in FIG. 5 is converted from a time axis to the signal source distance, and the half-wave envelope signal is extracted. As shown in FIG. 10, a signal-to-noise ratio of a damage signal is low and there is a plurality of peaks, making it difficult to determine a specific quantity of damages. When the envelope signal is used for imaging, a lot of artifacts are produced, which easily leads to false detection. Refer to FIG.

8. Separation and recognition of the A0 mode, S0 mode, and conversion mode of an example can be implemented by using technologies in this embodiment. Refer to FIG. 9. A final enhanced signal of an example has only two peaks. Compared with FIG. 5, a signal amplitude is greatly increased, and a signal-to-noise ratio is increased. When the final enhanced signal of the present invention is used for further imaging, no artifact is generated, false detection is less likely to occur, and a damage detection resolving capability and a precise positioning capability are improved. In addition, different modal damage signals generated by different damages are recognized, to improve a processing capability of a multi-damage complex signal.

This embodiment further provides a system for enhancing an ultrasonic guided wave signal based on multi-modal recognition and fusion, including:
an ultrasonic guided wave excitation probe and an ultrasonic guided wave receiving probe, where the ultrasonic guided wave excitation probe and the ultrasonic guided wave receiving probe may be a same probe or different probes for excitation and receiving;
an excitation module, where the excitation module generates and amplifies an excitation signal and generates an ultrasonic guided wave propagation signal within a detected structure through the ultrasonic guided wave excitation probe;
a collection-synchronous transmission module, where the collection-synchronous transmission module collects a detection signal through the ultrasonic guided wave receiving probe and synchronously transmits the detection signal to a data processing platform;
a detection control module, where the detection control module can control the excitation mode and the collection-synchronous transmission module; and
the data processing platform, where the data processing platform includes a frequency dispersion dictionary database generation module and a fusion and enhancement processing module of a multi-modal ultrasonic guided wave signal. Refer to FIG. 12.

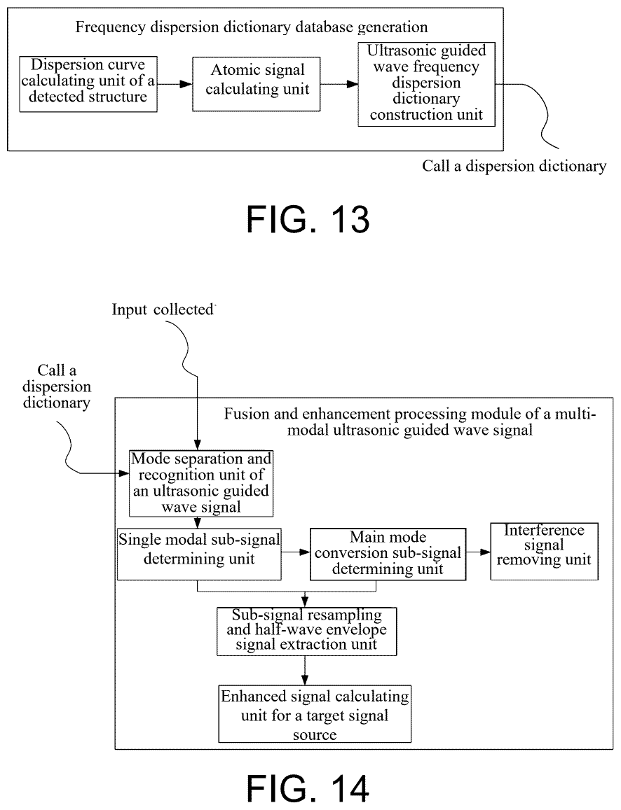

Refer to FIG. 13. The frequency dispersion dictionary database generation module can calculate a frequency dispersion curve of the detected structure, obtain dispersion signals such as a modal number, a wave number, a group velocity, and the like, and calculate, as atomic signals, a series of signals that propagate for a series of distances in the detected structure through a target detection mode, and form an ultrasonic guided wave frequency dispersion dictionary.

Refer to FIG. 14. The fusion and enhancement processing module of a multi-modal ultrasonic guided wave signal has a mode separation and recognition unit of an ultrasonic guided wave signal, a single modal sub-signal determining unit, a main mode conversion sub-signal determining unit, an interference signal removing unit, and a sub-signal resampling and half-wave envelope signal extraction unit, an enhanced signal calculating unit for a target signal source, and a function.

The mode separation and recognition unit of an ultrasonic guided wave signal calls and uses the ultrasonic guided wave frequency dispersion dictionary to perform modal signal separation and recognition on the ultrasonic guided wave signal, to obtain a series of sub-signals.

The single modal sub-signal determining unit performs first signal source distance conversion, and determines different modal sub-signals with a same or similar signal source distance as single modal sub-signals based on a modal recognition result and modal group velocity of the sub-signals, and divides the different modal sub-signals with a same or similar signal source distance into a same signal source target group.

The main mode conversion sub-signal determining unit performs second signal source distance conversion and assumes that the potential mode conversion sub-signal is a modal conversion signal of a main modal signal at a signal source based on the signal source distance and modal group velocity of the signal source target group, and determines, as a main mode conversion sub-signal, a potential mode conversion signal with a signal source distance the same as or similar to a source signal distance of the signal source target group.

The enhanced signal calculating unit for a target signal source can superpose half-wave envelope signals of the resampled sub-signals in a same signal source target group, to obtain an enhanced signal of the target signal source.

Although the implementations disclosed in the present invention are as above, the described content is only used to facilitate the understanding of the present invention and is not intended to limit the present invention. Any person skilled in the technical field to which the present invention belongs may make any modification and change in the form and details of the implementation without departing from the spirit and scope disclosed in the present invention. However, the patent protection scope of the present invention shall still be subject to the scope defined by the appended claims.

1. A method for enhancing an ultrasonic guided wave signal based on multi-modal recognition and fusion, comprising:
step A: solving an ultrasonic guided wave frequency dispersion curve of a detected structure, selecting n modes as target detection modes, and setting a mode with a strongest signal energy as a main mode;
step B: solving, as atomic signals, a series of signals of an ultrasonic guided wave excitation signal that propagates within a detected object through the target detection mode, to form an ultrasonic guided wave frequency dispersion dictionary;
step C: performing modal signal separation and recognition on the ultrasonic guided wave signal by using the ultrasonic guided wave frequency dispersion dictionary, to obtain a series of sub-signals;
step D: converting abscissa axes of the sub-signals from time to signal source distances based on a modal recognition result and modal group velocity of the sub-signals;
step E: determining different modal sub-signals with a same or similar signal source distance as single modal sub-signals and dividing the different modal sub-signals into a same signal source target group, and determining other sub-signals as potential mode conversion sub-signals;
step F: based on the signal source distance and modal group velocity of the signal source target group, assuming that the potential mode conversion sub-signal as a modal conversion signal of a main modal signal at a signal source, and converting an abscissa axis of the potential mode conversion sub-signal from time to a signal source distance;
step G: if the signal source distance of the potential mode conversion sub-signal is the same as or similar to a signal source distance of the signal source target group, determining the potential mode conversion sub-signal as a main mode conversion sub-signal and classifying the potential mode conversion sub-signal into the signal source target group, and determining other sub-signals as interference signals, and removing other sub-signals;
step H: resampling the single modal sub-signals and the main mode conversion sub-signals at a same sampling frequency and extracting half-wave envelope signals; and
step I: superposing half-wave envelope signals of resampled sub-signals of the same signal source target group, to obtain an enhanced signal of a target signal source.

2. The method for enhancing the ultrasonic guided wave signal based on multi-modal recognition and fusion according to claim 1, wherein in the selecting n modes as target detection modes in step A, the modes are selected based on a common damage type of the detected structure, a frequency f at which the ultrasonic signal is excited, a group velocity diagram, an energy ratio of each mode, and a sensitivity to a target damage type, wherein n≥2.

3. The method for enhancing the ultrasonic guided wave signal based on multi-modal recognition and fusion according to claim 1, characterized in that, wherein the solving, as atomic signals, signals of the ultrasonic guided wave excitation signal that propagates within a detected object through the target detection mode, to form an ultrasonic guided wave frequency dispersion dictionary in step B specifically comprises:
based on an ultrasonic guided wave frequency dispersion curve and a detection range of the detected structure, assuming a propagation distance set l={ln|ln=l0+n Δl} with an equal spacing of Δl between elements;
assuming that a signal of the excited ultrasonic signal e(t) that propagates for a propagation distance l in the tested structure is s(l, t)=ΣM m=1e(t)*p(l, f, m), wherein M is the number of guided wave modes, * is convolution, and p(l, f, m) is a dispersion function; and solving an atomic signal s(l, t, m) of a mode m by using an inverse Fourier transform of a Fourier transform S(l, w), which is expressed as:
$$s ( l , t , m ) = ( \int + ∞ - ∞ S ( 0 , w ) e - i ( wt - k ( w ) l ) dw ) * p ( l , f , m )$$
wherein k(w) is a wave number function of a frequency w; and solving, through a given target detection mode, the series of signals of the excitation signal that propagates for the propagation distance set l within the detected object through n target detection modes, to form the ultrasonic guided wave frequency dispersion dictionary.

4. The method for enhancing the ultrasonic guided wave signal based on multi-modal recognition and fusion according to claim 1, wherein for the modal signal separation and recognition in step C, signal sparse decomposition is performed on the collected ultrasonic guided wave signal based on a matching pursuit algorithm, a sub-signal is separated from a collected signal s(i, j), an atomic signal matching the sub-signal is set as s′n(l′, t, m′), and a mode m′ and a propagation distance l′ that matches the atomic signal in the ultrasonic guided wave frequency dispersion dictionary is recorded;
Wherein final residual signal energy obtained by using the modal signal separation is not greater than 20% of original signal energy.

5. The method for enhancing the ultrasonic guided wave signal based on multi-modal recognition and fusion according to claim 1, wherein the signal source distance in step D is a distance between a damage, a structural boundary, or an interface and an excitation point, and is solved based on a group velocity of a recognition mode of the sub-signal at an excitation frequency; and
the group velocity is obtained from a frequency dispersion curve.

6. The method for enhancing the ultrasonic guided wave signal based on multi-modal recognition and fusion according to claim 1, wherein the main mode conversion sub-signal is a signal that a main mode is subjected to mode conversion at a damage, a structural boundary or an interface.

7. A system for enhancing an ultrasonic guided wave signal based on multi-modal recognition and fusion, comprising:
an ultrasonic guided wave excitation probe and an ultrasonic guided wave receiving probe, configured to excite and receive an ultrasonic guided wave signal respectively;
an excitation module, generating and amplifying an excitation signal and generating an ultrasonic guided wave propagation signal within a detected structure through the ultrasonic guided wave excitation probe;
a collection-synchronous transmission module, collecting a detection signal through the ultrasonic guided wave receiving probe and synchronously transmitting the detection signal to a data processing platform;
a detection control module, configured to control the excitation module and the collection-synchronous transmission module; and
the data processing platform, comprising a frequency dispersion dictionary database generation module and a fusion and enhancement processing module of a multi-modal ultrasonic guided wave signal, wherein
the frequency dispersion dictionary database generation module is configured to calculate a frequency dispersion curve of the detected structure, obtain dispersion signals of a modal number, a wave number, and a group velocity, and calculate, as an atomic signal, a signal of an ultrasonic guided wave excitation signal that propagates in a detected object through a target detection mode, and construct an ultrasonic guided wave frequency dispersion dictionary;
the fusion and enhancement processing module of a multi-modal ultrasonic guided wave signal comprises a mode separation and recognition unit of an ultrasonic guided wave signal, a single modal sub-signal determining unit, a main mode conversion sub-signal determining unit, an interference signal removing unit, and a sub-signal resampling and half-wave envelope signal extraction unit, and an enhanced signal calculating unit for a target signal source;
the mode separation and recognition unit of an ultrasonic guided wave signal uses the ultrasonic guided wave frequency dispersion dictionary to perform modal signal separation and recognition on the ultrasonic guided wave signal, to obtain a series of sub-signals;
the single modal sub-signal determining unit performs first signal source distance conversion, and determines different modal sub-signals with a same or similar signal source distance as single modal sub-signals based on a modal recognition result and modal group velocity of the sub-signals, and divides the different modal sub-signals with a same or similar signal source distance into a same signal source target group;
the main mode conversion sub-signal determining unit performs second signal source distance conversion and assumes that the potential mode conversion sub-signal is a modal conversion signal of a main modal signal at a signal source based on the signal source distance and modal group velocity of the signal source target group, and determines, as a main mode conversion sub-signal, a potential mode conversion signal with a signal source distance the same as or similar to a source signal distance of the signal source target group; and
the enhanced signal calculating unit for the target signal source is configured to superpose half-wave envelope signals of the resampled sub-signals in a same signal source target group, to obtain an enhanced signal of the target signal source.
